(19) United States
(12) Patent Application Publication
(10) Pub. No.: US 2010/0092150 A1
(43) Pub. Date: Apr. 15, 2010

(54) SUCCESSIVE VIDEO RECORDING METHOD USING UDTA INFORMATION AND PORTABLE DEVICE THEREFOR

(75) Inventor: Jong Kyu BAE, Seoul (KR)

Correspondence Address: CHA & REITER, LLC, 210 ROUTE 4 EAST STE 103, PARAMUS, NJ, 07652, US

(73) Assignee: SAMSUNG ELECTRONICS CO., LTD., Gyeonggi-Do (KR)

(21) Appl. No.: 12/576,279

(22) Filed: Oct. 9, 2009

(30) Foreign Application Priority Data
Oct. 13, 2008 (KR) 10-2008-0100120

(51) Int. Cl. H04N 5/91; H04N 5/93; H04N 7/26

(52) U.S. Cl. 386/52; 386/117; 386/96; 386/109; 348/231.3; 386/E09.013; 386/E05.007; 386/E05.028

(57) ABSTRACT

A successive video recording method and portable device for recording video in continuation at the end of a previously-stored video file to create a merged video file without special editing applications or special skills. A video file stored in a storage unit of the portable device is selected, and a camera unit is activated a camera unit when the video file is selected. A new video file is generated by merging video data acquired by the camera unit in real time with the selected video file based on a successive recording information. The present invention enables recording video in formats including but in no way limited to Moving Picture Experts Group 1 (MPEG-4) in continuation at the end of a previously-stored video file, allowing the user to pause and resume video recording at any time and merge the video files into a single file using a successive recording mode.

### CLAIM OF PRIORITY

This application claims priority from an application entitled “SUCCESSIVE VIDEO RECORDING METHOD USING UDTA INFORMATION AND PORTABLE DEVICE THEREFOR” filed in the Korean Intellectual Property Office on Oct. 13, 2008 and assigned Serial No. 10-2008-0100120, the contents of which are incorporated herein by reference in its entirety.

### BACKGROUND OF THE INVENTION

1. Field of the Invention

The present invention relates to a portable video recording device. More particularly, the present invention relates to a successive video recording method and a portable device for recording video in continuation at the end of a previously stored video file.

2. Description of the Related Art

A Portable device typically refers to a mobile or handheld device (including Personal Mobile Communication Services Terminal, Personal Digital Assistant (PDA), Smartphone, International Mobile Telecommunication 200 (IMT-2000) terminal, and Wireless Local Area Network (WLAN) terminal, etc.) that incorporates diverse applications and functions as well as wireless voice communication capability.

With the rapid advance of technologies, more recent mobile phones (as the most popular portable device) are equipped to provide the user with a plurality of various functionalities such as video call, electric organizer, audio and video data storage, Internet access, and other entertainment features. Particularly, the integration of a digital camera into a mobile phone allows the user to capture still and motion pictures for use as background image or sending to other terminals.

Mobile phones are quickly becoming a necessity rather than a luxury item by people of all ages and both sexes all around the world. Accordingly, the mobile phone utilization is growing more and more popular for use in various purposes other than basic voice communication.

In order to meet the various requirements of the users of camera-equipped mobile phones, various camera-related applications and functions have been developed and integrated into the mobile phones. One of the most attractive camera-related applications is an image editor which allows the user to edit the picture captured with the camera. However, the conventional image edit method has drawbacks in that an additional editing tool is required and, even when an editing tool is installed, it is difficult to use and requires a long time to learn to use the editing tool due to its operational complexity.

### SUMMARY OF THE INVENTION

The present invention provides a successive video recording method and portable device for recording video in formats including but not limited to Moving Picture Experts Group 1 (MPEG-4) format in continuation at the end of a previously-stored video file. According to the present invention, by using a User Data atom (Udta) of the Moving Picture Experts Group 1 (MPEG-4) format, there is a reduction in the initialization time of the newly recorded part of the video file.

In accordance with an exemplary embodiment of the present invention, a successive video recording method of a portable device preferably includes: selecting a video file stored in a storage unit of the portable device; activating a camera unit of the portable device when the video file is selected; and generating a new video file by merging the video data acquired by the camera unit in real time with the selected video file based on a successive recording information.

Preferably, generating a new video file includes recording the video data acquiring by the camera unit; encoding the recorded video data with a codec indicated by the information on the type of codec used for encoding the video file; merging the encoded video data with the video file in continuation of the end of the video file; updating the frame table as the encoded video data is merged with the video file; and updating the entire playback time of the video file as a size of the video file increases by merging the video data acquired by the camera unit in real time.

In accordance with another exemplary embodiment of the present invention, a portable device supporting successive video recording preferably includes: a camera unit which acquires video data; a storage unit which stores the video data acquired by the camera unit and downloaded through a communication channel in the form of video files; an input unit which receives a user command for selecting one of video files stored in the storage unit; and a control unit which activates the camera unit in response to the user command and generates a new video file by merging the video data acquired by the camera unit in real time with the selected video file.

### BRIEF DESCRIPTION OF THE DRAWINGS

The above features and advantages of the present invention will become more apparent from the following detailed description in conjunction with the accompanying drawings, in which:

FIG. 1 is a block diagram illustrating a configuration of a portable device according to an exemplary embodiment of the present invention;

FIG. 2 is a schematic diagram illustrating a video file format for use in a successive video recording method according to an exemplary embodiment of the present invention;

FIG. 3 is a diagram how to generate a video file in the successive video file format of FIG. 2;

FIG. 4 is a diagram illustrating exemplary screen images at steps for activating successive video recording function in a portable device according to an exemplary embodiment of the present invention; and

FIG. 5 is a flowchart illustrating a successive video recording method according to an exemplary embodiment of the present invention.

### DETAILED DESCRIPTION

Exemplary embodiments of the present invention are described herein with reference to the accompanying drawings in detail. The same reference numbers are used throughout the drawings to refer to the same or like parts. Detailed descriptions of well-known functions and structures incorporated herein may be omitted to avoid obscuring appreciation of the subject matter of the present invention by a person of ordinary skill in the art.

Furthermore, in order to clearly illustrate the principles of the present invention, constituent parts constructing the present invention may not illustrated be to an exact scale thereof and some are exaggerated and some are omitted for simplicity. Thus, the claimed invention is not limited to the relative size or scale of any item shown in the drawings.

Although the successive video recording method and portable device is directed to a mobile phone in the following description, it should be clearly understood that a mobile phone is only a preference for explanatory purposes and the present invention is not limited thereto. For instance, the portable device can be any of a mobile communication terminal, a wireless/wired handset, a PDA, a Smartphone, a cellular phone (including Wideband Code Division Multiple Access (WCDMA) terminal, IMT-2000 terminal, Global System for Mobile communications/General Packet Radio Service (GPRS), Universal Mobile Telecommunication Service (UMTS) terminal), and their equivalent devices that are equipped with a camera, just to name a few examples of devices which may benefit from incorporating the present invention.

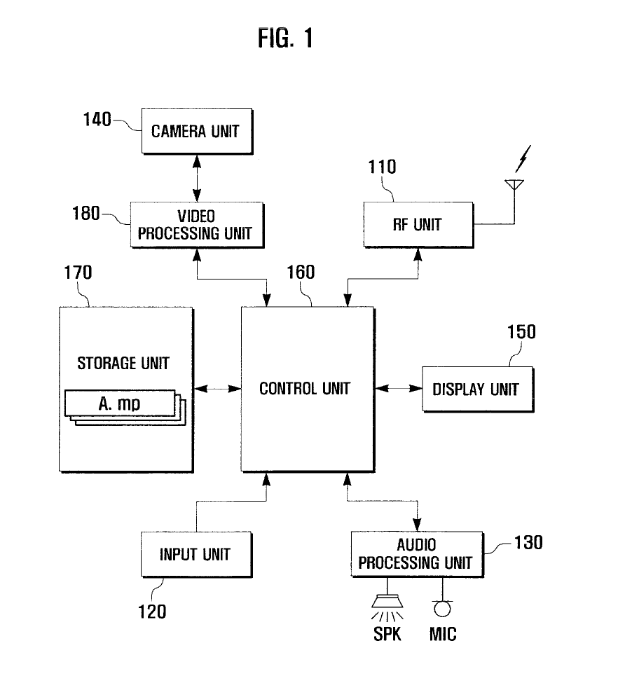

FIG. 1 provides a general overview of the structure and functions of a portable device according to an exemplary embodiment of the present invention. FIG. 1 is a block diagram illustrating one possible configuration of a portable device according to an exemplary embodiment of the present invention.

Referring now to FIG. 1, the portable device 100 preferably includes in this example a Radio Frequency (RF) unit 110, an audio processing unit 130, an input unit 120, a camera unit 140, a display unit 150, a video processing unit 155, a control unit 160, and a storage unit 170.

The RF unit 110 is responsible for two-way radio communication of the portable device 100. The RF unit includes an RF transmitter for up-converting and amplifying the transmission signal and an RF receiver for low noise amplifying and down-converting received signal. The RF unit 110 provides the radio signal received through wireless channel and transmits the signal output by the control unit 160 through the wireless channel. In a particular exemplary embodiment of the present invention, the RF unit 110 can establish a data communication channel with another device to transmit a motion picture stored previously stored in the storage unit 170 to another device and receives a motion picture transmitted by the other device under the control of the control unit 160.

The audio processing unit 130 preferably includes a coder/decoder (codec), a speaker (SPK) for outputting the audio signal processed by the codec, and a microphone (MIC) for receiving auditory sound. The codec can include, for example, a data codec for processing packet data and an audio codec for processing audio signals. The audio processing unit 130 converts the digital audio signal output by the control unit 160 into an analog signal by operation of the audio codec, and outputs the analog signal through the speaker in the form of an audible sound wave, and converts the analog audio signal input through the microphone into the digital audio signal and outputs the digital audio signal to the control unit 160.

More particularly, the audio processing unit 130, for example, may process the audio signal input while a video is recorded by the camera unit 140. When the user wants to couple the currently recorded video to the end of a previously-stored video file, the audio processing unit 130 records the audio signal in synchronization with the currently recorded video and provides the recorded audio signal to the control unit 160.

Still referring to FIG. 1, the input unit 120 receives a signal corresponding to a user manipulation and provides a corresponding sequence to the control unit 160. The input unit 120 is preferably provided with a plurality of alphanumeric keys for inputting alphabetic and numeric data, and a plurality of function keys for configuring and execution operations of the portable device. Particularly in an exemplary embodiment of the present invention, the input unit 120 is configured to generate and output the input signals for selecting a video file stored in the storage unit 170, executing successive video recording function, and saving the recorded video to the control unit 160 in response to the user input. It is within the spirit and scope of the claimed invention that a touch screen having an image of physical keys can be used instead of actual buttons.

The camera unit 140 may preferably include, for example, a camera sensor and a signal processor. The camera sensor converts the optical signal input through a camera lens into an electric signal. The camera sensor can be one of a Charge Coupled Device (CCD) sensor and a Complementary Metal Oxide Semiconductor (CMOS) sensor. The signal processor converts the analog video signal output by the camera sensor into digital data. The signal processor can be a Digital Signal Processor (DSP) or signal other processor.

The video processing unit 180 processes the video signal output from the camera unit 140 in a digital data format by frames suitable for display on the display unit 150. The video processing unit 180 also outputs the video data to the control unit 160 in a compressed format. The video processing unit 180 includes video codecs to compress and/or decompress the video data to permit the user to view the video. The video codecs include JPEG codec, MPEG codec, Wavelet codec, and so forth.

The display unit 150 displays the video data supplied by the video processing unit 180. The display unit 150 can be implemented with any known thin screen technology, which in this example comprises Liquid Crystal Display (LCD). In the case of LCD, the display unit 150 can include an LCD controller, a video memory for temporarily storing the video data, and LCD devices. When the LCD supports touchscreen function, the display unit 150 can be configured to operate as a part of the input unit 120. The display unit 150 can be configured to display the video data input through the camera unit 140 in the form of a preview image.

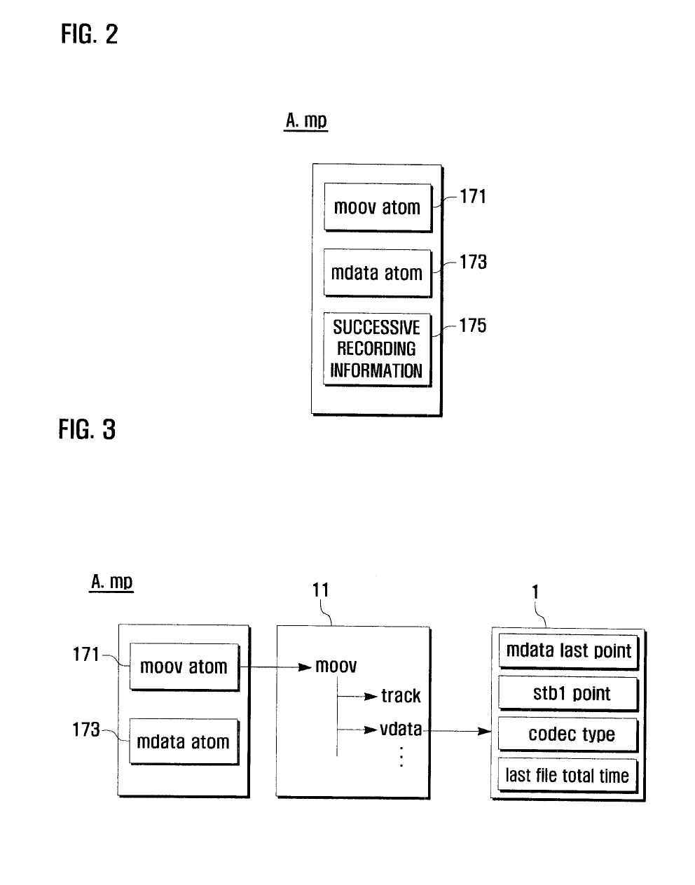

With continued reference to FIG. 1, the storage unit 170 includes a program memory and at least one data memory. The program memory stores application programs running in association with the functions of the portable device. The data memory stores application data generated while the application programs are running. More particularly, the storage unit 170 preferably stores the video data corresponding to the video images captured by operation of the camera unit 140 and received by operation of the RF unit 110. The video data is stored in a video format (e.g. A.mp) having a header, a video data, and successive recording information that enables successive video recording in continuation of the end of the previously-stored video file. The video format is described in detail with reference to FIGS. 2 and 3.

The control unit 160 controls entire operations of the portable device. The control unit 160 controls such that the video data taken by operation of the camera unit 140 or received by operation of the RF unit 110 is saved in the successive recording format (e.g. A.mp) according to user command. That is, the control unit 160 controls such that a video file is stored along with the Udta information indicating whether the video file supports the successive recording format (A.mp). When the user selects a successive recording format video file, the control unit 160 activates the camera unit 140 and aligns the start frame of video data input through the camera unit 140 to follow the end frame of the successive recording format video file (A.mp) such that the newly recorded video data is merged with successive recording format video file (A.mp) in a successive manner.

In case that the user wants to record video data in continuation of a video file which is stored in a non-successive recording format, the control unit 160 can converts the video file into the successive recording format and then controls the camera unit 140 to perform the successive video recording with the converted video file. The video file format conversion operation will now be described in more detail with reference to FIGS. 2 and 3.

FIG. 2 is a schematic diagram illustrating a video file format for use in a successive video recording method according to an exemplary embodiment of the present invention, and FIG. 3 is an explanatory diagram for generating a video file in the successive video file format of FIG. 2.

Referring now to FIG. 2, a successive recording file format according to an exemplary embodiment of the present invention is preferably composed of a header 171, a media data 173, and a successive recording information 175.

The header 171 contains the information that describes the media data 173. For instance, the header 171 includes information on the track video data such as resolution, title, codec, playback time, compression format, and data format type.

The media data 173 contains actual media data. The media data 173 can be stored in a predetermined compression format according to the data format type and compression format specified in the header 171. The media data 173 can be stored in units of frames. In this case, the media data frames can be stored in a sequential order or according to a rule specified in the data format type. Accordingly, it is not always the case that the last frame of the media data is stored in the last region of the entire storage space allocated for the media data.

The successive recording information 175 is the information required for recording the video data in continuation of the end of the video file selected by the user. The successive recording information 175 is stored when a recording session complete for the next successive recording. It is preferred that the successive recording information is stored in a region separated from the header 171.

An explanation of one way to create a successive recording format video file (A.mp) is described hereinafter with reference to FIG. 3.

As shown in FIG. 3, the previously-stored video file includes a header region 171 and a media data region 173. If a user input for converting a non-successive recording format video file to a successive recording format video file (A.mp), the control unit 1 extracts a successive recording information contained in a the user data atom (Udta) of an information tree (moov) of the header region 171. In more detail, the header region 171 including the information such as track atom and user data atom (Udta) in the form of a tree (moov) as denoted by reference numeral 11. A user data atom (Udta) includes property information of the media data 173 as denoted by reference numeral 1. The user data atom (Udata) in the head region 171 includes a “mdata last point” containing the information on the last point of the last one of the stored media data, a “stb1 point” containing the position at which a table is stored in the file containing information of the media data 173, a “codec type” containing the information on the codec for the stored media data, and a “last file total time” containing the information on the playback time of the lastly stored file.

With continued reference to FIG. 3, if a user input for converting the non-successive recording format video file to a successive recording format video file, the control unit 160 checks the user data atom (Udata) and extracts the information required for activating the successive recording function, i.e. “medata last point”, “stb1 point”, “codec type” and “last file total time”. This extraction of information is not performed for analyzing the entire header 171, but for reducing the initialization time for the successive video recording by analyzing only the Udta information. The control unit 160 converts the extracted information to activate the successive recording and stores in the next region of the media data 173 of the video data. In order to record the video data in continuation of the previously-stored video file, the information on the last frame of the corresponding video file should be acquired. The control unit 160 can acquire the information on the last frame of the previously-stored video file from the “mdata last point” stored in the successive video recording information. In order to record video data input by the camera unit 140 using the same codec as the successive recording format video file, the control unit 160 refers to the “codec type” information stored in the successive video recording information. Also, in order to update the entire file playback time while recording the video data in continuation of the successive recording format video file, the control unit 160 can acquire the information on the entire file playback time from the “last file total time” stored in the successive video recording information.

Although it is described herein that the success video recording information is stored in a region separated from the header region 171, the presently claimed invention is not limited thereto, as the information can be stored, for example, in a part of the header region 171. In this case, an additional information element can be added to the tree of the header in order for the control unit 160 to retrieve the successive video recording information from the header region. That is, when the successive video recording information is generated while converting the non-successive recording format file into the successive recording format file, the control unit 160 can add the information to the hierarchical tree in the header region 171. Afterward, if the corresponding successive recording format file is selected by the user to record video in continuation of the selected successive recording format file, the control unit checks the tree items related to the successive recording information from the header region 171 and extracts the successive recording information.

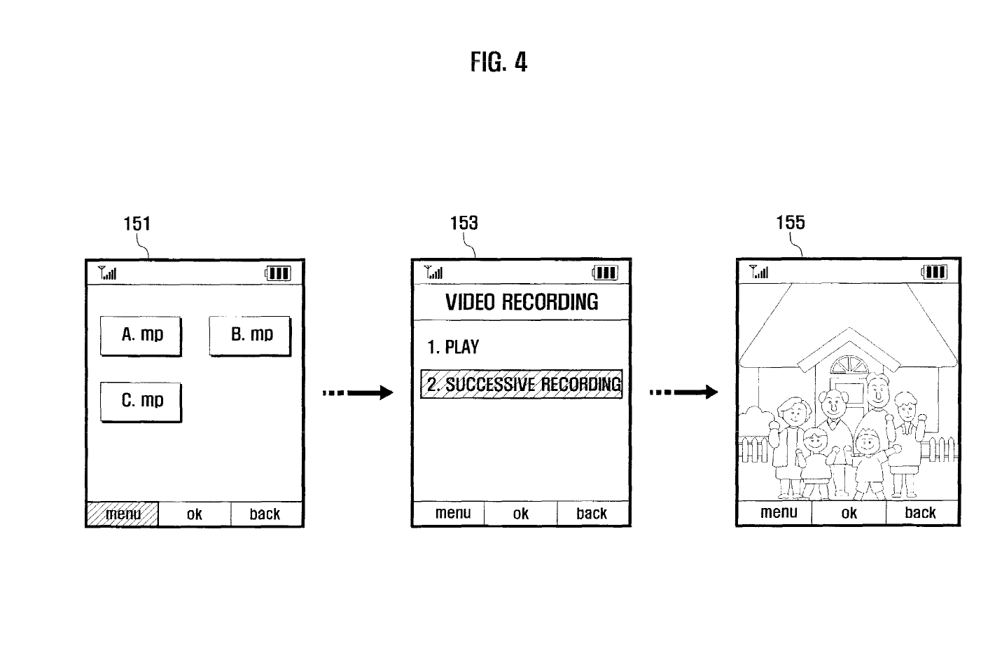

FIG. 4 is a diagram illustrating exemplary screen images during steps for activating a successive video recording function in a portable device according to an exemplary embodiment of the present invention.

Referring now to FIG. 4, if a user command to search for video files stored in the storage unit 170 is detected, the control unit 160 controls such that the display unit 150 displays the video files stored in the storage unit 170 as shown in the screen image denoted by reference numeral 151. In the example of FIG. 4, there are three video files, i.e. A.mp, B.mp, and C.mp, that are retrieved and corresponding icons are displayed on the display unit 150. If one of the video files is selected, the control unit 160 controls such that a video file related menu is displayed on the display unit 150 as shown in the screen image denoted by reference numeral 153. In the example of FIG. 4, the video file related menu includes a “playback” menu item and a “successive recording” menu item.

If the user selects the second menu item, i.e. the “successive recording” menu item, the control unit 160 switches on the camera unit 140 and displays a preview image input through the camera unit 140 on the display unit 150, as shown in the screen image denoted by reference numeral 155. As discussed herein above, the control unit 160 checks the successive recording information region in the data structure of the selected video file and extracts the successive recording information and recording the video data input through the camera unit 140 in continuation of the selected video file based on the successive recording information and stores as a merged video file.

In the case where any successive recording information is detected in the video file selected by the user while preparing to perform the successive recording function, the control unit 160 checks the head region of the video file, extracts the user data among the data specified in the header region, and selects the information items required for performing the successive video recording. Next, the control unit 160 updates the successive recording information and saves the updated successive recording information in the data structure of the video file. At the same time, the control unit 160 activates the camera unit 140 such that the camera unit 140 is initialized to record the video data using the aforementioned successive recording information, thereby creating a merged video file. The control unit 160 can output alerts of extraction and update of the successive recording information.

As described in the above examples, the portable device supporting the successive video recording function provides recording video data input through the camera unit in continuation of the end of a previously-stored video file, thereby negating an additional merging process afterward. Accordingly, the user can merge the video data captured in real time with the previously-stored video file in simple way.

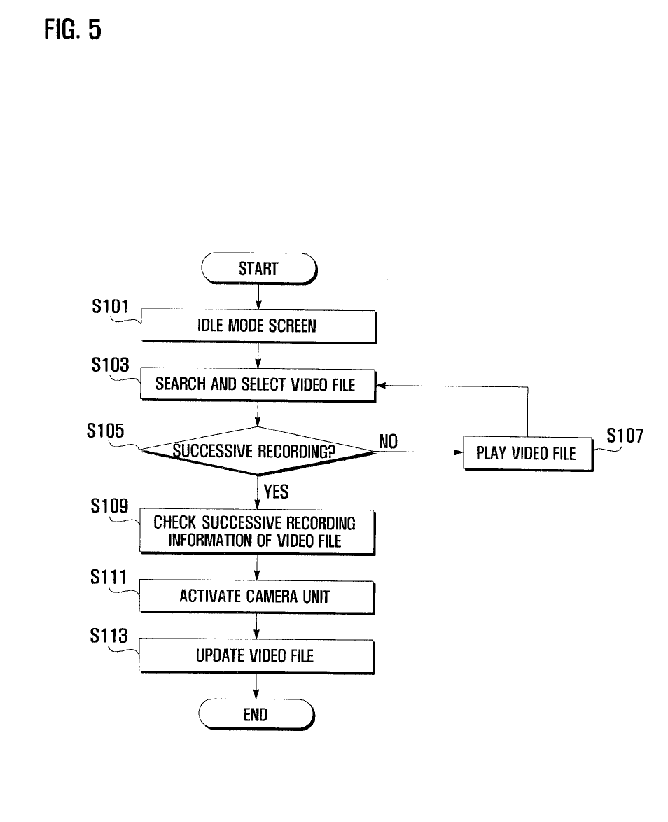

The structure and screen interface of the portable device for accomplishing the successive video recording have been described hereinabove. A successive video recording method according to another exemplary embodiment of the present invention is now described with reference to FIG. 5.

FIG. 5 is a flowchart illustrating exemplary operations of a successive video recording method according to an exemplary embodiment of the present invention.

Referring now to FIG. 5, once the portable device switches on, the control unit 160 of the portable device boots up and controls the portable device enters an idle mode with a display of an idle mode screen at switch-on (101).

Next, at step (103), the control unit 160 searches for the video files and displays the searched files in response to a video file search command and selects one of the searched files in response to a selection command input by the user. In order for the user to input the series of user commands, the control unit can control a display of a list of items representing the searched video files and a menu screen having menu items available for the selected video file.

With continued reference to FIG. 5, at step (105) the control unit 160 detects a selection command input for selecting a menu item on the menu screen and determines whether the selected menu item is a “successive recording”. The menu can be presented in the form of a popup window and include a “playback” menu item and the “successive recording” menu item, as one possible non-limiting example of how the selected menu may be presented.

If the selected menu item is the “playback” menu item, the control unit 160 controls the portable device to play the selected video file (107). Once the playback of the selected video file completes or is canceled, the procedure returns to step 103.

Otherwise, at step (105) if the selected menu item is the “successive video recording” menu item at step 105, the control unit 160 extracts a successive recording information (Udta) from the selected video file (109). At this time, the control unit 160 analyzes the data structure of the selected video and checks whether a separate successive recording-related information region exists in the data structure before inspecting the entire header region. When there is no separate successive recording-related information region exists, the control unit 160 checks a tree including the successive recording-related information in the entire header region. In this case, there can be a little latency for inspecting the entire header region. A successive recording-related information is found in the tree, the control unit 160 extracts the successive recording-related information from the tree.

However, if there is no successive recording-related information in the successive recording information region in the header region or no other successive recording information region separated from the header region or the media data region, the control unit 160 determines that the video file comprises a non-successive recording format video file. In this case, the control unit 160 extracts information elements required for the successive video recording from the header region of the video file. For instance, the control unit 160 extracts the information on the time point when the last data of the media data is stored, the codec type of the video data, the position where type frame table containing the characters of each frame of the media data, and the playback time of the entire data of the video file. Next, the control unit 160 creates the successive recording information based on the extracted information and inserts the created successive recording information into a separate region (Udta tree) of the corresponding video file or forms a new tree to insert the created successive recording information.

After checking the successive recording information, at step (111) the control unit 160 activates the camera unit 140 to take video data to be merged in continuation of the end of the selected video file. Finally, the control unit 160 updates the video file by merging the newly recorded video data with the selected video file (113). In more detail, the control unit 160 controls such that the start frame of the video data recorded currently follows the end frame of the selected file so as to be merged into a successive single video file based on the last frame information extracted from the successive recording information. At this time, the currently recorded video data are encoded by the same codec as the selected video file. Also, the playback time of the entire video file is updated as the video file length is increased due to the addition of the newly recorded video data.

As described above, the successive video recording method and portable device of the present invention enables the video data recorded in real time to be merged with a previously-stored video file automatically without additional editing process.

Also, the successive video recording method and portable device of the present invention activates a microphone at the same time of the activation of the camera unit, when the previously stored video file includes audio data, such that the newly recorded video data is merged with the previously stored video file in synchronization with the audio data collected by operation of the microphone.

Also, the successive video recording method and portable device of the present invention allows the user to pause and resume video recording at any time and merge the video files into a single file by using a successive recording mode, thereby creating a merged video file without requiring an additional editing application and high video editing skill to create such a merged video file.

Although exemplary embodiments of the present invention have been described in detail hereinabove, it should be clearly understood that many variations and/or modifications of the basic inventive concepts herein taught which may appear to those of ordinary skill in the art will still fall within the spirit and scope of the present invention, as defined in the appended claims.

What is claimed is:

1. A portable device supporting successive video recording, comprising:
a camera unit for acquiring video data;
a storage unit for storing the video data acquired by the camera unit in a form of video files;
an input unit for receiving a user command for selecting one of the video files stored in the storage unit; and
a control unit for activating the camera unit in response to the user command and for generating a new video file by merging the video data acquired by the camera unit in real time with the selected video file.

2. A portable device of claim 1, wherein the video file comprises a header region, a video data region, and a successive recording information region.

3. The portable device of claim 2, wherein the successive recording information region comprises:
information on an end point of the video data of the video file;
information on a position of a frame table including characteristics of frames of media data corresponding to frame values of the video data; and
information on an entire playback time of the video file.

4. The portable device of claim 3, wherein the control unit encodes the video data acquired by the camera unit by operation of a codec used for encoding the selected video file and by merging the encoded video data with the selected video file in continuation of an end of the selected video file.

5. The portable device of claim 3, wherein the control unit updates the entire playback time of the video file when a size of the video file increases by merging the video data acquired by the camera unit in real time.

6. The portable device of claim 1, wherein the new video file comprises a header region and a video data region, the header region comprising a successive recording information stored in the form of a tree.

7. The portable device of claim 1, wherein the control unit extracts: information on an end point of the video data of the video file, information on a position where a frame table storing characteristics of frames of media data corresponding to frame values of the video data, and information on an entire playback time of the selected video file from the header region, and generates a successive recording information, when the selected video file has no successive recording information region.

8. The portable device of claim 1, further comprising a microphone for acquiring audio data, wherein the control unit activates the microphone at substantially a same time as activation of the camera unit, and the control unit controls storing the audio data acquired by the microphone in synchronization with the video data acquired by the camera unit while the video data is merging with the selected video file.

9. The portable device of claim 1, wherein the video data acquired by the camera unit is downloaded through a communication channel in a form of video files.

10. The portable device of claim 1, wherein the control unit generates the new video file by merging the video data acquired by the camera unit in real time with the selected video file without requiring the user to operate an editing application.

11. The portable device of claim 1, wherein in a successive recording mode, the portable device permits pausing and resuming of a video recording at any time and the video files are merged into a single file.

12. The portable device of claim 11, wherein a format of the single file comprises Moving Picture Experts Group 1 (MPEG-4).

13. A successive video recording method of a portable device comprising:
selecting a video file stored in a storage unit of the portable device;
activating a camera unit of the portable device when the video file is selected; and
generating a new video file by merging the video data acquired by the camera unit in real time with the selected video file based on a successive recording information.

14. The successive video recording method of claim 13, wherein the successive recording information comprises:
information on an end point of the video data of the selected video file;
information on a type of codec used for encoding the selected video file;
information on a position where a frame table storing characteristics of frames of media data corresponds to frame values of the video data; and
information on an entire playback time of the selected video file.

15. The successive video recording method of claim 14, wherein generating a new video file comprises:
recording the video data acquired by the camera unit;
encoding the recorded video data with a codec indicated by the information on the type of codec used for encoding the video file;
merging the encoded video data with the selected video file in continuation at the end of the selected video file;
updating the frame table as the encoded video data is merged with the selected video file; and
updating the entire playback time of the video file as a size of the video file increases by merging the video data acquired by the camera unit in real time.

16. The successive video recording method of claim 13, further comprising:
determining whether the selected file includes a successive recording information region;
checking, when the selected video file has no successive recording information region, a user-defined data in a header region of the selected video file;
extracting information on an end point of the video data of the selected video file, information on a position where a frame table storing characteristics of frames of media data corresponding to frame values of the video data, and information on an entire playback time of the selected video file from the user-defined data, and generating the successive recording information; and
storing the successive recording information in a region separated from the header region.

17. The successive video recording method of claim 13, further comprising:
determining whether the selected video file includes a successive recording information region;
checking, when the selected video file has no successive recording information region, a user-defined data in a header region of the selected video file;
extracting information on an end point of the video data of the selected video file, information on a position where a frame table storing characteristics of frames of media data corresponding to frame values of the video data, and information on an entire playback time of the selected video file from the user-defined data, and generates the successive recording information;
creating a new region of a tree information structure in the header region; and
writing the successive recording information in the new region.

18. The successive video recording method of claim 13, further comprising:
activating a microphone at substantially a same time of activation of the camera unit; and
storing audio data acquired by the microphone in synchronization with the video data acquired by the camera unit while the video data is merging with the selected video file.

19. The method according to claim 13, further comprising merging into the new file data acquired by the camera unit as video recording by the camera unit is repeatedly paused and resumed.

20. The method of claim 13, wherein a format of the new video file comprises Moving Picture Experts Group 1 (MPEG-4).
